(19) United States
(12) Patent Application Publication
(10) Pub. No.: US 2025/0154044 A1
(43) Pub. Date: May 15, 2025

(54) METHOD OF UTILIZATION OF A SUBMERGED NOZZLE FOR CHALCOGENIDE GLASS

(71) Applicant: CORNING INCORPORATED, CORNING, NY (US)

(72) Inventors: Curtis Richard Cowles, Corning, NY (US); Patrick Paul Gill, Watkins Glen, NY (US); George Paul Lindberg, Corning, NY (US)

(21) Appl. No.: 18/941,846

(22) Filed: Nov. 8, 2024

Related U.S. Application Data
(60) Provisional application No. 63/599,126, filed on Nov. 15, 2023.

(51) Int. Cl. C03B 19/02

(52) U.S. Cl. CPC C03B 19/025; C03B 2201/86

(57) ABSTRACT

A method of forming a chalcogenide glass element, the method includes depositing molten chalcogenide glass from an injection tip of a nozzle and into a cavity of a mold at a flow rate, the nozzle being inserted into the cavity, and during the depositing, moving at least one of the nozzle and the cavity relative to each other to substantially fill the cavity with the molten chalcogenide glass, and changing the speed of the at least one of the nozzle and the cavity based upon alignment of the injection tip with a cross-sectional radius of the cavity.

This application claims the benefit of priority under 35 U.S.C § 120 of U.S. Provisional Application Ser. No. 63/599,126 filed on Nov. 15, 2023, the content of which is relied upon and incorporated herein by reference in its entirety.

### FIELD

The following disclosure generally relates to systems and methods for forming a chalcogenide glass element.

### BACKGROUND

Chalcogenide glass is a type of glass that comprises one or more elements from group 6 of the periodic table. Chalcogenide glass is popular in many applications because it exhibits unique optical and electrical qualities. For example, chalcogenide glass transmits primarily in the infrared spectrum with an electronic band edge shift from blue to red as the base chalcogen shifts from sulfur to tellurium. Chalcogenide glass containing sulfur appears red and has a band edge cutoff in the 600 nm range whereas chalcogenide glass containing tellurium has a band edge cutoff in the micron range. Transmission of these chalcogenide glasses is generally high from the band edge to the phonon (vibrational) edge at about 8 microns. On the other hand, chalcogenide glass with heavier elements from group 6 can transmit out to almost 20 microns.

The most common chalcogenide glass typically includes a combination of about 40% arsenic and about 60% selenium. This chalcogenide glass has excellent transmission from about 800 nm to 14 microns. Comparatively, other commercially available materials for long-wave infrared (“LWIR”) applications include germanium and antimony and usually have a large absorption at 12.5 microns that inhibits transmission. The constituent elements of the arsenic and selenium and the purity of metal needed to synthesize quality chalcogenide glass are very expensive. Chalcogenide glass is typically synthesized in a batch process involving vacuum sealing the materials into a quartz ampule and reacting the elements at high temperatures forming a boule that can be later processed into a lens. This process typically involves either cutting the boule into near net shapes and traditionally forming a lens via grind and polish or diamond turning. Alternatively, the boule may be cut to form precision polished spheres and then pressed into a lens using precision molding methods.

These traditional methods of forming chalcogenide glass elements are usually difficult, expensive, and materially inefficient. More particularly, these traditional methods can oftentimes result in about 50%-70% material waste. One major contributing factor to the difficultly in forming chalcogenide glass elements is that oxygen impurities in the part-per-million (“ppm”) range will start to inhibit transmission in the 11-14 micron region, which is where chalcogenide glass elements are utilized most. Accordingly, there is a continuing effort to provide alternative and improved methods of formation.

### SUMMARY

According to one embodiment, a method of forming a chalcogenide glass element includes depositing molten chalcogenide glass from an injection tip of a nozzle and into a cavity of a mold at a flow rate, the nozzle being inserted into the cavity, and during the depositing, moving at least one of the nozzle and the cavity relative to each other to substantially fill the cavity with the molten chalcogenide glass, and changing the speed of the at least one of the nozzle and the cavity based upon alignment of the injection tip with a cross-sectional radius of the cavity.

According to another embodiment, an apparatus for forming a chalcogenide glass element includes a mold that defines a channel extending from an inlet port to an outlet port, the channel comprising a plurality of cavities positioned along the channel. A nozzle connected to a reservoir configured to hold chalcogenide glass preform material, the nozzle comprising an injection tip configured to deposit the chalcogenide glass preform material into the plurality of cavities. A movement component is configured to move at least one of the nozzle and the mold relative to one another to position the injection tip in each of the cavities and through the channel.

According to yet another embodiment, the speed of the relative movement is modified inversely proportionally to a size of the cavity cross-sectional area and/or radius.

Additional features and advantages will be set forth in the detailed description which follows and, in part, will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is an upper perspective view of a system for forming a chalcogenide glass element, according to aspects of the present disclosure;

FIG. 2A is top cross-sectional view of a nozzle depositing molten chalcogenide glass into a channel downstream from a cavity, according to aspects of the present disclosure;

FIG. 2B is top cross-sectional view of a nozzle depositing molten chalcogenide glass into a first cross-sectional area of a cavity, according to aspects of the present disclosure;

FIG. 2C is top cross-sectional view of a nozzle depositing molten chalcogenide glass into a second cross-sectional area of a cavity, according to aspects of the present disclosure;

FIG. 2D is top cross-sectional view of a nozzle depositing molten chalcogenide glass into a channel upstream from a cavity, according to aspects of the present disclosure;

FIG. 3 is a plot of the speed of a mold vs. process time for depositing molten chalcogenide glass into a channel, according to aspects of the present disclosure;

FIG. 4 is a schematic view of a control system for a system for forming a chalcogenide glass element, according to aspects of the present disclosure;

FIG. 5 is a first flow chart of a method for forming a chalcogenide glass element, according to aspects of the present disclosure;

FIG. 6 is a second flow chart of a method for forming a chalcogenide glass element, according to aspects of the present disclosure; and

FIG. 7 is a third flow chart of a method for forming a chalcogenide glass element, according to aspects of the present disclosure.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The following disclosure generally relates systems and methods for forming a chalcogenide glass element. The following terms as used herein have the following meanings.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error, production limitations, and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “formed from” can mean one or more of comprises, consists essentially of, or consists of. For example, a component that is formed from a particular material can comprise the particular material, consist essentially of the particular material, or consist of the particular material.

The term “chalcogenide glass” is a type of glass that comprises one or more elements from group 6 of the periodic table. Similarly, the term “chalcogenide glass element” is a shaped product formed from chalcogenide glass.

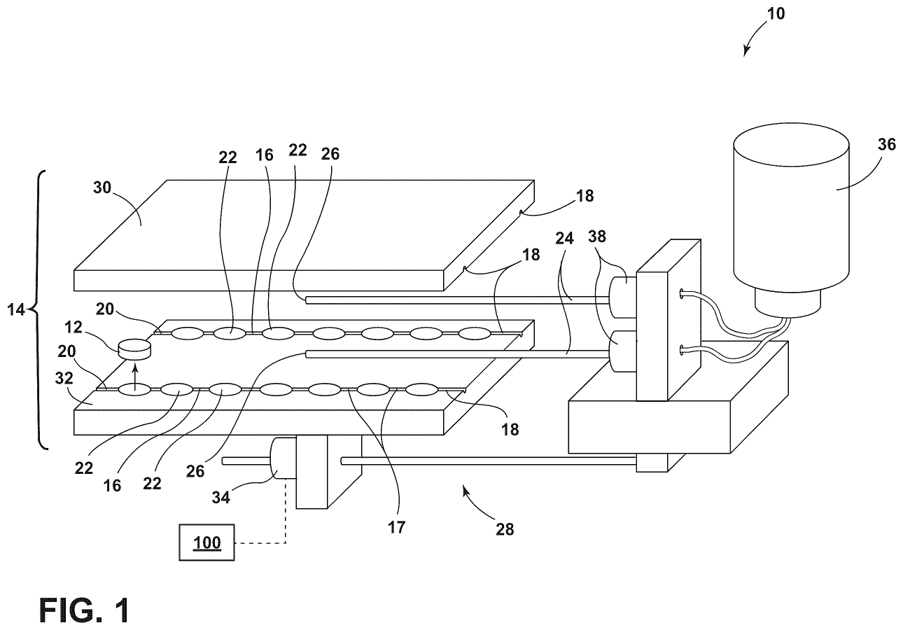

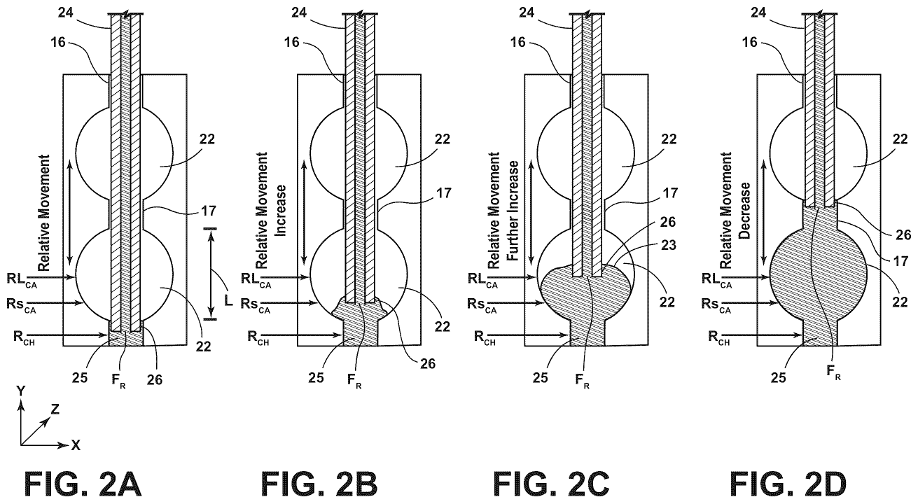

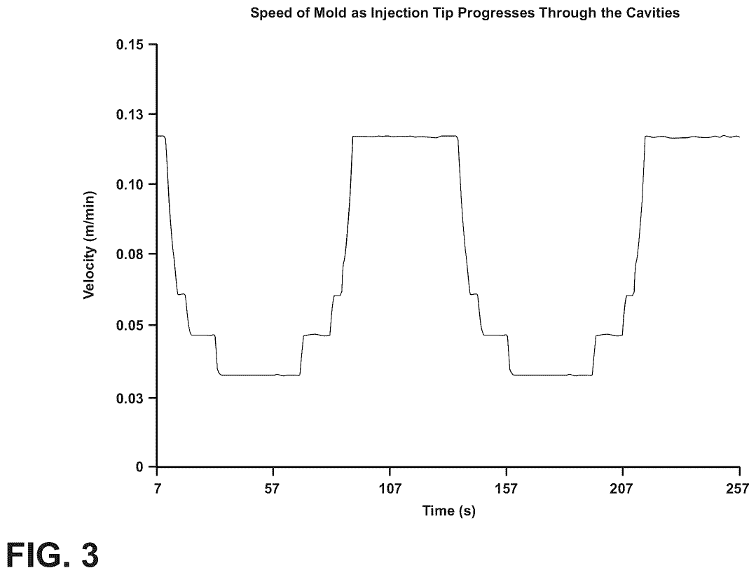

Referring to FIGS. 1-3, a molding system 10 for forming a chalcogenide glass element 12 comprises a mold 14 that defines a channel 16 extending from an inlet port 18 to an outlet port 20. The channel 16 comprises one or more cavities 22 along the length of the channel 16 such that at least one cavity 22 is located along the channel 16 between the inlet port 18 and the outlet port 20. As shown in FIG. 1, adjacent cavities 22 are separated by portions 17 of channel 16. A nozzle 24 is configured to deposit a molten chalcogenide glass 25 at a flow rate “F_{R}” into the channel 16. The nozzle 24 comprises an injection tip 26 that, in embodiments, is positioned in the channel 16. A movement unit 28 is configured to effectuate a relative movement (FIGS. 2A-2D) between the mold 14 and the nozzle 24. A control system 100 includes a processor 104 and a memory 106 (FIG. 3), the memory 106 includes instructions that, when executed by the processor 104, cause the processor 104 to modify a speed of the relative movement between the mold 14 and the injection tip 26.

With reference to FIG. 1, the mold 14 may include a first mold half 30 and a second mold half 32. FIG. 1 shows the first mold half 30 and the second mold half 32 as separated from each other. In use, the two mold halves are brought into alignment such that the first mold half 30 is in direct contact with the second mold half 32 to form the channel 16. In some embodiments, each mold half 30, 32 partially defines the channel 16 and the at least one cavity 22 so that the channel 16, including that at least one cavity 22, is fully formed when the mold halves are brought into alignment and in direct contact with each other. The at least one cavity 22 may include a plurality of cavities 22 sequentially spaced along the channel 16. Therefore, channel 16 forms a passageway connecting each of the spaced cavities 22. Each cavity 22 may comprise a lens-shape. The spacing between cavities 22 may be equal or unequal. In some embodiments, the mold 14 comprises two or more channels 16, with each channel 16 defining one or more cavities 22. Therefore, mold 14 may comprise a plurality of cavities 22 disposed along each channel 16 within the mold 14. Likewise, the nozzle 24 may include two or more nozzles 24 such that multiple cavities 22 can be filled contemporaneously. Each nozzle 24 may be associated with a channel 16 such that the number of nozzles 24 corresponds to the number of channels 16 in system 10.

The movement unit 28 may include a gear-driven arrangement (e.g., a rack and pinion, lead screw, and/or the like), a hydraulic or pneumatic arrangement, or any other means of moving the mold 14 and/or nozzle 24 relative to each other. The movement unit 28 may be driven by an actuator 34 (e.g., a motor, a pump, and/or the like). In some embodiments, the movement unit 28 is configured to move the mold 14 relative to the nozzle 24, the nozzle 24 relative to the mold 14, or both the mold 14 and nozzle 24 together.

The nozzle 24 may be in fluid communication with a reservoir 36 (e.g., a source of molten chalcogenide glass) configured to hold chalcogenide glass preform material. The preform material in the reservoir 36 may be molten or otherwise become molten prior to deposition into the channel 16 and cavity 22. The preform material (e.g., molten chalcogenide glass) may be selectively deposited through the nozzle 24 via a regulator valve 38. In some embodiments, the regulator valve 38 may be configured to modify the flow rate F_{R}.

With reference now to FIGS. 2A-2D, each cavity 22 defines a cavity cross-sectional area and the portions 17 of channel 16 between the adjacent cavities 22 define a channel cross-sectional area that is smaller than the cross-sectional area of the cavity 22. The cross-sectional area of each cavity 22 may be non-uniform along a length “L” of the cavity 22 and may be defined by at least one portion with a relatively larger radius RL_{CA} and at least one portion with a relatively smaller radius RS_{CA} such that RS_{CA}<RL_{CA}. Furthermore, the radius R_{CH} of the portions 17 of channel 16 in between the cavities 22 may be smaller than each of RL_{CA} and RS_{CA} such that R_{CH}<RL_{CA} and R_{CH}<RS_{CA}. Due to the larger radius of the cavities 22 compared to the portions 17 of channel 16, the cavities 22 comprise a relatively larger cross-sectional area. It is noted that the cross-sectional area of the cavities 22 and of portions 17 each refer to the cross-sectional area along a plane that extends along the Z-axis, as shown in FIGS. 2A-2D (along a plane that extends into the page of FIGS. 2A-2D and that is perpendicular to the movement direction of the nozzle 24 and/or mold 14). Therefore, the portion of cavity 22 with the relatively larger radius RL_{CA} will have a relatively larger cross-section than the portion of cavity 22 with the relatively smaller radius RS_{CA}. For purposes of this disclosure, the term cross-sectional area further means an area or size of a given cross-section that becomes filled with the molten chalcogenide glass 25. In some embodiments, the cross-sectional area of the portion 17 of channel 16 is substantially uniform along the length of the portion.

The control system 100 (e.g., the processor 104) is configured to modify the speed of relative movement (e.g., by the movement unit 28) between the nozzle 24 and the mold 14 based on the alignment of the injection tip 26 with the relative cross-sectional size of the channel 16. More particularly, the relative movement becomes slower as the injection tip 26 becomes aligned with a larger cross-sectional area of the cavity 22. Stated another way, the relative movement becomes slower as the injection tip 26 becomes aligned with the portion of the cavity 22 with the relatively larger radius RL_{CA}. Furthermore, the relative movement between the nozzle 24 and the mold 14 becomes faster as the injection tip 26 becomes aligned with a smaller cross-sectional area of the cavity 22. Stated another way, the relative movement becomes faster as the injection tip 26 becomes aligned with the portion of the cavity 22 with the relatively smaller radius RS_{CA}. And the relative movement becomes even faster as the injection tip 26 is aligned with the portion 17 of the channel 16 between the cavities 22. Stated another way, the relative movement becomes even faster as the injection tip 26 is aligned with the portion 17. For purposes of the present disclosure, “aligned” means that the components are located along the same plane in the x-direction of FIGS. 2A-2D. Therefore, for example, when the injection tip 26 is “aligned” with the portion of the cavity 22 with the relatively larger radius RL_{CA}, the end of the ejection tip 26 is located along the same plane in the x-direction as the portion of the cavity 22 with the radius RL_{CA}.

In embodiments, the nozzle 24 and/or the mold 14 moves at a first speed S₁ when the ejection tip 26 is aligned with the portion 17 of the channel 16, moves at a second speed S₂ when the ejection tip 26 is aligned with the radius RS_{CA}, and moves at a third speed S₃ when the ejection tip is aligned with the radius RL_{CA}, such that S₁>S₂>S₃. The relative speed of the nozzle 24 and/or the mold 14 may cause a change in the flow rate F_{R} of the molten chalcogenide glass 25 from the ejection tip 26, such that a higher speed corresponds to a higher flow rate F_{R}. In other embodiments, the speed of the nozzle 24 and/or the mold 14 changes while the flow rate F_{R} of the molten chalcogenide glass 25 remains the same (or substantially the same). In yet other embodiments, the flow rate F_{R} of the molten chalcogenide glass 25 changes (based upon the alignment of ejection tip 26 with radii RL_{CA}, RL_{CA}, and R_{CH}) while the speed of the nozzle 24 and/or the mold 14 remains the same, or substantially the same.

With continued reference to FIGS. 2A-2D, it should be appreciated that the relatively smaller cross-sectional radius RS_{CA} and the relatively larger cross-sectional radius RL_{CA} of the cavity 22 are merely exemplary in nature. In embodiments, the cavity 22 includes numerous (e.g., more than two) cross-sectional radii having different sizes depending on the desired molded form of the chalcogenide glass element 12. For example, the cavity 22 may be at least partially rounded such that a perimeter of the cross-section of the cavity 22 can be defined by a gradient of increasing or decreasing radii sizes. Nonetheless, the speed of relative movement between the nozzle 24 and the mold 14 may be inversely proportional to the size of the cross-sectional radius in alignment with the injection tip 26. For purposes of the disclosure, the term “inversely proportional” simply means that as one quantity increases (e.g., the radius) another quantity decreases (e.g., the speed of relative movement).

With continued reference still to FIGS. 2A-2D, the speed of relative movement between nozzle 24 and mold 14 is modified to utilize the surface tension of the molten chalcogenide glass 25. By modifying the speed of the nozzle 24 and/or the mold 14 (e.g., between speeds S₁, S₂, S₃) depending on the location of the ejection tip 26 relative to the different radii sizes (e.g., RL_{CA}, RS_{CA} R_{CH}), the molten chalcogenide glass 25 can adhere to itself as it deposited from the ejection tip 26, thus forming an even dispersion of the glass from the ejection tip 26. By modifying the speed of the nozzle 24 and/or mold 14, as disclosed herein, the glass is ejected from ejection tip 26 at an optimal rate so that the glass will adhere to itself and form a continuous stream of glass from the ejection tip 26. As shown in FIG. 2D, for example, the glass adheres to itself so that a continuous stream of glass is deposited from the ejection tip 26 into the cavity 22 and so that the ejection tip 26 is submerged in the deposited glass. Because the ejection tip 26 is submerged in the deposited glass, the glass is able to be deposited in a continuous stream and directly into the cavity 22. In contrast, if the glass is not ejected from ejection tip 26 at the optimal rates disclosed herein, the glass will not adhere to itself and, instead, may drip out from ejection tip 26 as discrete droplets. Such discrete droplets can cause, for example unwanted bubbles or voids in the deposited glass within cavities 22. In other cases, if the glass is not ejected from ejection tip 26 at the optical rates disclosed herein, the glass may overfill the cavities 22, causing an overflow of the mold 14.

As used herein, surface tension (measured in Newton/meter) is the tension of an outer surface layer 23 of the deposited molten chalcogenide glass 25 caused by the attraction of particles in surface layer 23. Due to the surface tension of the deposited molten chalcogenide glass 25, surface layer 23 tends to be drawn together due to forces of attraction within this surface layer (in order to expose the smallest possible surface area of surface layer 23). When the speed of relative movement between nozzle 24 and mold 14 is modified as disclosed in the embodiments herein, surface layer 23 is able to maintain its drawn together state due to the surface tension of the glass 25. Therefore, surface layer 23 bunches up and around ejection tip 26 of nozzle 24 while the molten glass fills up cavity 22 and/or portion 17 of channel 16 (so that the ejection tip 26 is submerged in the deposited glass). However, when the speed of relative movement between nozzle 24 and mold 14 is too high, the surface layer 23 is not able to maintain its drawn together state. Instead, the molten glass deposited from nozzle 24 may drip from ejection tip 26 as separate and discrete droplets. These separate and discrete droplets may cool too quickly and negatively impact the formation of glass within the cavities. Additionally, the separate and discrete droplets may cause formation of bubbles in the formed glass. Or when the speed of the relative movement between nozzle 14 and mold is too slow, the deposited molten chalcogenide glass 25 may overflow the cavity 22.

In the embodiments disclosed herein, the speed of relative movement between nozzle 24 and mold 14 is tuned so that the ejection tip 26 of the nozzle 24 remains submerged in the deposited molten chalcogenide glass 25. FIGS. 2A-2D show the ejection tip 26 submerged in the deposited molten chalcogenide glass 25 during the entire deposition of the molten chalcogenide glass 25 into the cavities 22 and the portion 17 of channel 16. When the ejection tip 16 is submerged in the deposited molten chalcogenide glass 25, surface layer 23 is able to maintain its drawn together state (due to the surface tension of the glass 25) so that the cavities 22 and remainder of channel 16 are optimally filled with reduced or no formation of bubbles.

With reference again to FIGS. 2A-2D, an exemplary process of modifying the relative speed of the nozzle 24 and the mold 14 to utilize the surface tension of the molten chalcogenide glass 25 is depicted. In FIG. 2A, the injection tip 26 is inserted into the inlet port 18 and through channel 16 to the outlet port 20. Thus, the nozzle 24 extends through the cavities 22 and the portion 17 of the channel 16. After insertion, the molten chalcogenide glass 25 is deposited from the ejection tip 26 and into the channel 16 near the outlet port 20, and relative movement is effectuated between the mold 14 and the nozzle 24 to form the surface tension at outer surface 23. In FIG. 2A, the ejection tip 26 is aligned with radius R_{CH} of portion 17 of channel 16 so that the nozzle 24 and/or mold 14 moves at the first speed S₁.

In FIG. 2B, due to the relative movement of nozzle 24 and mold 14, the injection tip 26 is now positioned within the cavity 22 so that the ejection tip 26 is aligned with the smaller radius RS_{CA} of the cavity 22. Due to such alignment, the speed of the nozzle 24 and/or mold 14 decreases so that the nozzle 24 and/or mold 14 now moves at the second speed S₂ (wherein S₂<S₁). The change in speed from S₁ to S₂ allows the surface tension of surface layer 23 to remain and for the ejection tip 26 to continue to be submerged in the deposited glass.

In FIG. 2C, due to the continued relative movement of nozzle 24 and mold 14, the injection tip 26 is now positioned within the cavity 22 so that the ejection tip 26 is aligned with radius RL_{CA} of the cavity 22. Due to such alignment, the speed of the nozzle 24 and/or mold 14 decreases again so that the nozzle 24 and/or mold 14 now moves at the third speed S₃ (wherein S₃<S₂). The change in speed from S₂ to S₃ allows the surface tension of surface layer 23 to remain and for the ejection tip 26 to continue to be submerged in the deposited glass.

In FIG. 2D, due to the continued relative movement of nozzle 24 and mold 14, the injection tip 26 is now exterior of the cavity 22 and again positioned within the portion 17 of channel 16. The speed of the nozzle 24 and/or mold 14 now increases so that the nozzle 24 and/or mold 14 moves at the first speed S₁ again.

It is noted that the relative change in speeds are only depicted in FIGS. 2A-2D for the bottom half of the cavity 22 (where the radii RL_{CA} and RS_{CA} are depicted in the figures). However, the nozzle 24 and/or mold 14 may also have modified speeds when the ejection tip 26 is positioned within the top half of the cavity 22. In embodiments, the top half of the cavity 22 may have similar radii (RL_{CA} and RS_{CA}) as the bottom half of the cavity 22 so that the relative speeds produced in the bottom half of the cavity 22 would be mirrored in the top half of the cavity 22.

In embodiments, the first speed S₁ of the nozzle 24 and/or mold 14 (when the ejection tip 26 is aligned with radius R_{CH} of portion 17 of the channel 16) may be in a range from about 0.08 m/min to about 0.15 m/min, or about 0.09 m/min to about 0.12 m/min, or about 0.10 m/min to about 0.11 m/min. In embodiments, the second speed S₂ of the nozzle 24 and/or mold 14 (when the ejection tip 26 is aligned with radius RS_{CA} of cavity 22) may be in a range from about 0.03 m/min to about 0.08 m/min, or about 0.04 m/min to about 0.07 m/min, or about 0.05 m/min to about 0.06 m/min. In embodiments, the third speed S₃ of the nozzle 24 and/or mold 14 (when the ejection tip 26 is aligned with radius RL_{CA} of cavity 22) may be in a range from about 0.01 m/min to about 0.03 m/min, or about 0.02 m/min to about 0.03 m/min. FIG. 3 shows an exemplary embodiment of the change of speed of a mold 14 as the ejection tip 26 is aligned with the different cross-sectional radii of the channel 16 and within two cavities 22 spaced along the channel 16. As shown in FIG. 3, the speed is modified and varies as the mold 14 moves.

In embodiments, the molten chalcogenide glass 25 is at a temperature from about 400° C. to about 450° C., or about 410° C. to about 440° C., or about 420° C. to about 430° C. The molten chalcogenide glass 25 may flow from the ejection tip 26 at a flow rate F_{R} of about 0.01 kg/min to about 0.10 kg/min, or about 0.02 kg/min to about 0.09 kg/min, or about 0.03 kg/min to about 0.08 kg/min, or about 0.04 kg/min to about 0.07 kg/min, or about 0.05 kg/min to about 0.06 kg/min. The surface tension of the glass at surface layer 23 may be in a range from about 9×10⁻⁶ N/m to about 1.2×10⁻⁵ N/m, or about 9.5×10⁻⁶ N/m to about 1.15×10⁻⁵ N/m, or about 1×10⁻⁵ N/m to about 1.05×10⁻⁵ N/m.

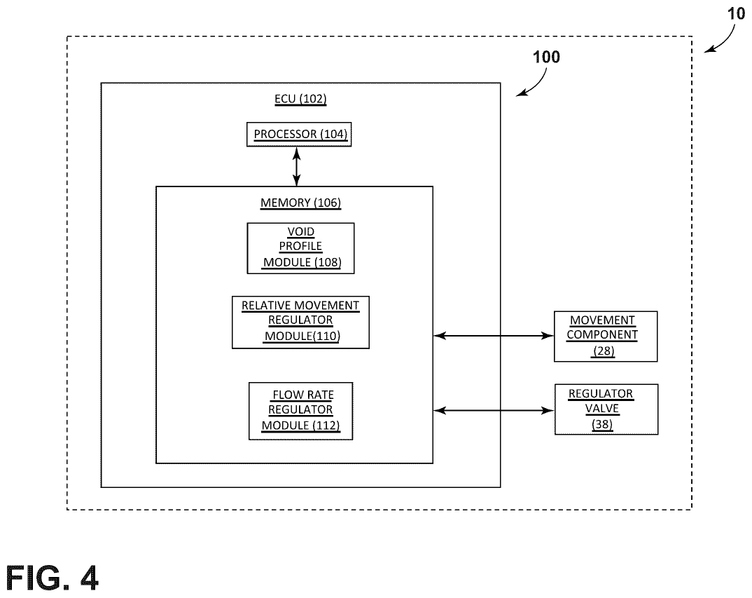

With reference now to FIG. 4, the control system 100 may include at least one electronic control unit (ECU) 102. The at least one ECU 102 may include the processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the molding system 10. The movement component 28 (e.g., the actuator 34), the speed (S₁, S₂, S₃) of the nozzle 24 and/or the mold 14, the flow rate F_{R} from the nozzle 24, and movement of the first mold half 30 and the second mold half 32, may, therefore, be controlled by the control system 100. The memory 106 may, therefore, include a void profile module 108 that includes the changes in size of cross-sectional areas and radii between the inlet port 18 and the outlet port 20 of the channel 16 and the cavities 22. The memory 106 may further include a relative movement regulator module 110 that includes a speed of relative movement associated with the cross-sectional area and radius in alignment with the injection tip 26. The memory 106 may further yet include a flow rate regulator module 112 that includes the speed (S₁, S₂, S₃) of the nozzle 24 and/or the mold 14 and the flow rate F_{R} corresponding to the void profile module 108 and the relative movement regulator module 110.

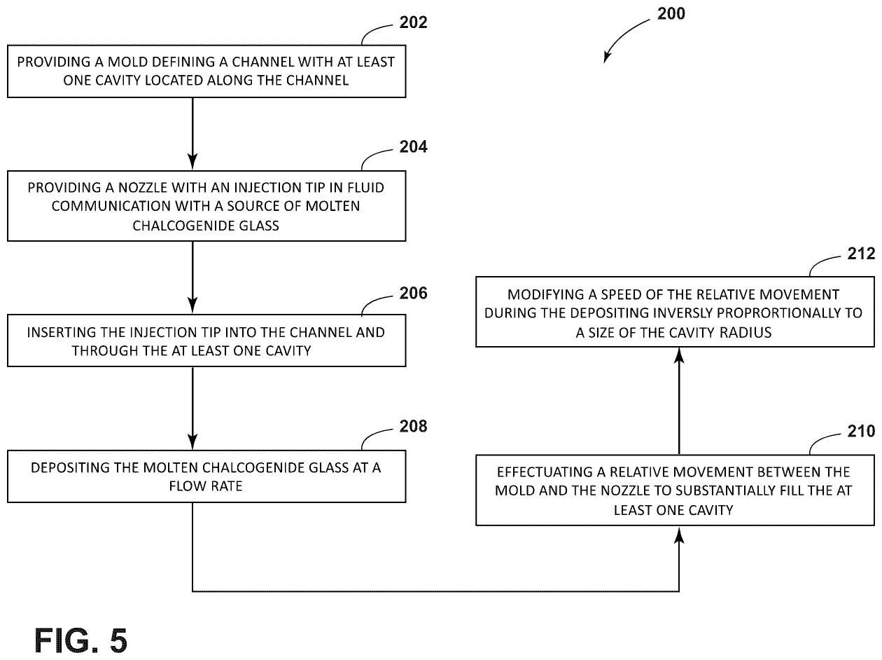

With reference now to FIG. 5, a method 200 of forming a chalcogenide glass element includes, at step 202, providing a mold defining a channel with at least one cavity located along the channel. At step 204, a nozzle is provided with an injection tip in fluid communication with a source of molten chalcogenide glass. At step 206, the injection tip is inserted into the channel and through the at least one cavity. At step 208, the molten chalcogenide glass is then deposited at a flow rate. In some embodiments, the depositing includes depositing the molten chalcogenide glass into the channel prior to the at least one cavity.

At step 210, as the molten chalcogenide glass is deposited, the nozzle is removed from the at least one cavity by effectuating a relative movement between the mold and the nozzle to substantially fill the at least one cavity. For example, the control system 100 (e.g., the processor 104) effectuates relative movement between the mold and the nozzle. A speed of the relative movement may be regulated based on the void profile module 108. In some embodiments, the void profile module 108 may include a plurality of void profiles associated with different cross-sectional areas and radii that define a molded form of the chalcogenide glass element. As such, step 210 may further include selecting a void profile out of a plurality of void profiles.

With continued reference to FIG. 5, each of the at least one cavity defines a cavity radius, and the channel defines a channel radius that is smaller than the cavity radius. As such, step 212 may include reducing a speed of the relative movement during the depositing when the injection tip becomes aligned with each of the at least one cavity. In some embodiments, the radius of the cavity 22 is non-uniform along a perimeter of the cross-section of the cavity and includes at least one radius and at least one smaller radius. Accordingly, step 212 may further include modifying a speed of the relative movement during the depositing inversely proportionally to a size of the cavity radius. More particularly, the speed of the relative movement may be slower when the injection tip becomes aligned with the at least one larger radius and the speed of the relative movement may be faster when the injection tip becomes aligned with the at least one smaller radius. The relative movement between the mold and the nozzle may include movement of only the nozzle, only the mold, or contemporaneous movement of both the nozzle and the mold. In this manner, the speed of relative movement may be inversely proportional to the size of the radius in alignment with the injection tip.

With continued reference still to FIG. 5, the at least one cavity may include a plurality of cavities sequentially spaced linearly along the channel. In this manner, the speed of the relative movement between the mold and the nozzle (e.g., as profiled in the void profile module 108) may be modified in a sequence, decreasing as the injection tip becomes aligned with each cavity and decreasing further as the tip becomes aligned with a larger radius of the cavity. The molded form of the chalcogenide glass element 12, as defined by the cavity, may be a lens-shape. At step 212, the method may include removing the molded form defined by the channel, such that the method results in a plurality of separate molded forms defined by the cavities (e.g., a plurality of lenses).

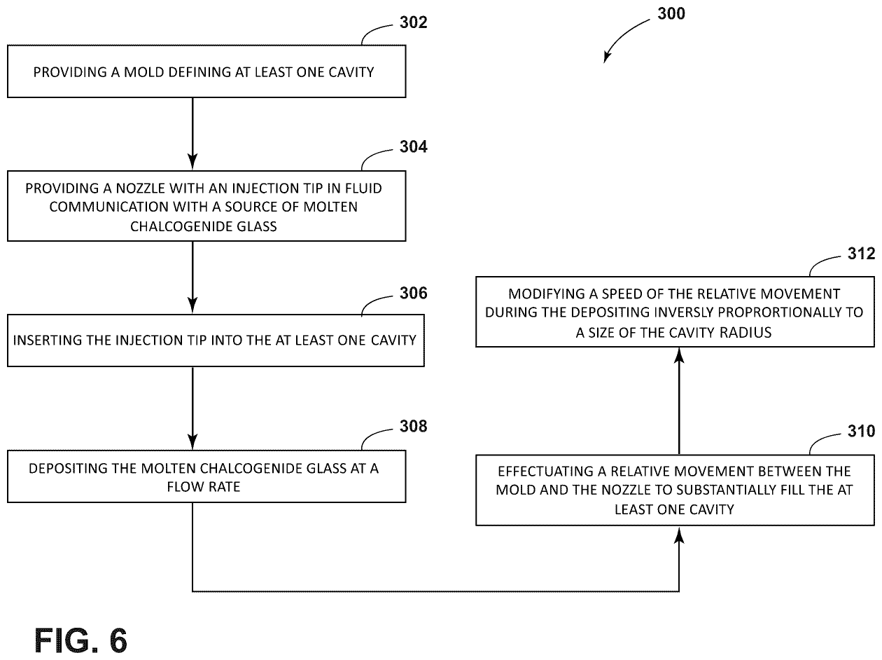

With reference now to FIG. 6, a second method 300 of forming a chalcogenide glass element includes, at step 302, providing a mold defining at least one cavity. At step 304, a nozzle is provided with an injection tip in fluid communication with a source of molten chalcogenide glass. At step 306, the injection tip is inserted into a near end of the at least one cavity, through the at least one cavity, to a far end of the at least one cavity. At step 308, the molten chalcogenide glass is then deposited at a flow rate.

At step 310, as the molten chalcogenide glass is deposited, the injection tip is removed from the at least one cavity (e.g., from the far end towards the near end) by effectuating a relative movement between the mold and the nozzle to substantially fill the at least one cavity. For example, the control system 100 (e.g., the processor 104) effectuates relative movement between the mold and the nozzle. A speed of the relative movement may be modified based on the void profile module 108 that includes the changes in the size of the radius of the cross-section of the cavity from the far end to the near end that includes at least one larger radius and at least one smaller radius. The speed of the relative movement may be modified in conjunction with the relative movement regulator module 110 that controls a movement component.

With continued reference to FIG. 6, at step 312, the method 300 includes modifying a speed of the relative movement during the depositing inversely proportionally to a size of the radius. More particularly, the speed of the relative movement may be slower when the injection tip becomes aligned with the at least one larger radius and the speed of the relative movement may be faster when the injection tip becomes aligned with the at least one smaller radius. The relative movement between the mold and the nozzle may include movement of only the nozzle, only the mold, or contemporaneous movement of both the nozzle and the mold. In this manner, the speed of relative movement may be inversely proportional to the size of the radius in alignment with the injection tip. A molded form of the chalcogenide glass element, as defined by the at least one cavity, may be a lens-shape.

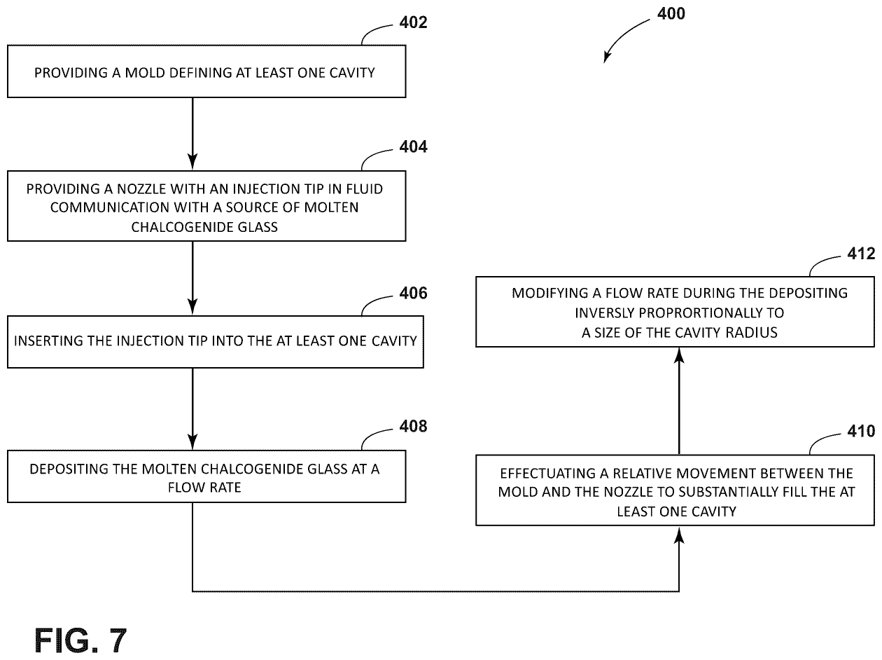

With reference now to FIG. 7, a third method 400 of forming a chalcogenide glass element includes, at step 402, providing a mold defining at least one cavity. At step 404, a nozzle is provided with an injection tip in fluid communication with a source of molten chalcogenide glass. At step 406, the injection tip is inserted into a near end of the at least one cavity, through the at least one cavity, to a far end of the at least one cavity. At step 408, the molten chalcogenide glass is then deposited at a flow rate.

At step 410, as the molten chalcogenide glass is deposited, the injection tip is removed from the at least one cavity (e.g., from the far end towards the near end) by effectuating a relative movement between the mold and the nozzle to substantially fill the at least one cavity. For example, the control system 100 (e.g., the processor 104) effectuates relative movement between the mold and the nozzle. The flow rate may be regulated based on the void profile module 108 that includes the changes in size of radii of the cavity from the far end to the near end that includes at least one larger radius and at least one smaller radius. The flow rate may be modified in conjunction with the flow rate regulator module 112 that controls a flow rate from a regulator valve.

With continued reference to FIG. 7, at step 412, the method 400 includes modifying the flow rate during the depositing inversely proportionally to a size of the cavity cross-section radius. More particularly, the flow rate may be greater when the injection tip becomes aligned with the at least one larger radius and the flow rate may be less when the injection tip becomes aligned with the at least one smaller radius. A molded form of the chalcogenide glass element, as defined by the at least one cavity, may be a lens-shape.

The invention disclosed herein is further summarized in the following paragraphs and is further characterized by combinations of any and all of the various aspects described therein.

According to a first embodiment, a method of forming a chalcogenide glass element, the method comprising depositing molten chalcogenide glass from an injection tip of a nozzle and into a cavity of a mold at a flow rate, the nozzle being inserted into the cavity and, during the depositing, moving at least one of the nozzle and the cavity relative to each other to substantially fill the cavity with the molten chalcogenide glass, and changing the speed of the at least one of the nozzle and the cavity based upon alignment of the injection tip with a cross-sectional radius of the cavity.

According to a second embodiment, the method of the first embodiment, wherein the cavity comprises at least a portion with a relatively smaller cross-sectional radius and a portion with a relatively larger cross-sectional radius, the method further comprising (i) moving the at least one of the nozzle and the cavity at a faster speed when an ejection tip of the nozzle is aligned with the relatively smaller cross-sectional radius of the cavity, and (ii) moving the at least one of the nozzle and the cavity at a slower speed when the ejection tip of the nozzle is aligned with the relatively larger cross-sectional radius of the cavity.

According to a third embodiment, the method of the second embodiment, wherein the faster speed is in a range from about 0.03 m/min to about 0.08 m/min.

According to a fourth embodiment, the method of the third embodiment, wherein the faster speed is in a range from about 0.04 m/min to about 0.07 m/min.

According to a fifth embodiment, the method of the first through fourth embodiments, wherein the slower speed is in a range from about 0.01 m/min to about 0.03 m/min.

According to a sixth embodiment, the method of the fifth embodiment, wherein the slower speed is in a range from about 0.02 m/min to about 0.03 m/min.

According to a seventh embodiment, the method of the first embodiment, wherein the depositing comprises depositing the molten chalcogenide glass into a channel of the mold with a smaller radius than a minimum radius of the cavity prior to depositing the molten chalcogenide glass into the cavity.

According to an eight embodiment, the method of the seventh embodiment, wherein the cavity comprises at least a portion with a relatively smaller cross-sectional radius and a portion with a relatively larger cross-sectional radius, the method further comprising (i) moving the at least one of the nozzle and the cavity at a first speed S₁ when an ejection tip of the nozzle is aligned with the channel with the smaller radius than the minimum radius of the cavity, (ii) moving the at least one of the nozzle and the cavity at a second speed S₂ when the ejection tip of the nozzle is aligned with the relatively smaller cross-sectional radius of the cavity, and (iii) moving the at least one of the nozzle and the cavity at a third speed S₃ when the ejection tip of the nozzle is aligned with the relatively larger cross-sectional radius of the cavity, wherein each of the first speed S₁, the second speed S₂, and the third speed S₃ are different from each other.

According to a ninth embodiment, the method of the eight embodiment, wherein the first speed S₁ is greater than the second speed S₂, and the second speed is greater than the third speed S₃.

According to a tenth embodiment, the method of the first through ninth embodiments, further comprising during the depositing, moving the nozzle relative to the cavity.

According to an eleventh embodiment, the method of the first through ninth embodiments, further comprising during the depositing, moving the cavity relative to the nozzle.

According to a twelfth embodiment, the method of the first through eleventh embodiments, wherein a cross-sectional perimeter of the cavity is non-uniform along a length of the cross-section.

According to a thirteenth embodiment, the method of the first embodiment, further comprising modifying a speed of the at least one of the nozzle and the cavity during the depositing inversely proportionally to a radius size of a cross-section of the cavity.

According to fourteenth embodiment, the method of the first through thirteenth embodiments, wherein the cavity comprises a plurality of cavities sequentially spaced along a channel of the mold.

According to a fifteenth embodiment, the method of the fourteenth embodiment, wherein the channel extends substantially linearly.

According to a sixteenth embodiment, the method of the first through fifteenth embodiments, wherein the cavity defines a lens shape.

According to a seventeenth embodiment, the method of the first through sixteenth embodiments, wherein the molten chalcogenide glass is at a temperature from about 400° C. to about 450° C.

According to an eighteenth embodiment, the method of the first through seventeenth embodiments, wherein the flow rate that the molten chalcogenide glass is deposited from the injection tip and into the cavity of the mold is from about 0.01 kg/min to about 0.10 kg/min.

According to a nineteenth embodiment, the method of the eighteenth embodiment, wherein the flow rate is from about 0.02 kg/min to about 0.09 kg/min.

According to a twentieth embodiment, the method of the first through nineteenth embodiments, wherein the ejection tip remains submerged in the molten chalcogenide glass deposited into the cavity.

According to a twenty-first embodiment, the method of the first through twentieth embodiments, wherein an outer surface layer of the molten chalcogenide glass deposited into the cavity has a surface tension from about 9×10⁻⁶ N/m to about 1.2×10⁻⁵ N/m.

According to a twenty-second embodiment, the method of the twenty-first embodiment, wherein the surface tension is from about 9.5×10⁻⁶ N/m to about 1.15×10⁻⁵ N/m.

According to a twenty-third embodiment, an apparatus for forming a chalcogenide glass element, the apparatus comprising a mold defining a channel extending from an inlet port to an outlet port, the channel comprising a plurality of cavities positioned along the channel, a nozzle connected to a reservoir configured to hold chalcogenide glass preform material, the nozzle comprising an injection tip configured to deposit the chalcogenide glass preform material into the plurality of cavities, and a movement component configured to move at least one of the nozzle and the mold relative to one another to position the injection tip in each of the cavities and through the channel.

According to a twenty-fourth embodiment, the apparatus of the twenty-third embodiment, wherein the channel extends linearly.

According to a twenty-fifth embodiment, the apparatus of the twenty-third or twenty-fourth embodiments, wherein each of the plurality of cavities define a lens-shape.

According to a twenty-sixth embodiment, the apparatus of the twenty-third through twenty-fifth embodiments, wherein the movement component is configured to move the nozzle.

According to a twenty-seventh embodiment, the apparatus of the twenty-third through twenty-fifth embodiment, wherein the movement component is configured to move the mold.

It will be apparent to those skilled in the art that various modifications and variations can be made without departing from the spirit or scope of the claims.

What is claimed is:

1. A method of forming a chalcogenide glass element, the method comprising:
depositing molten chalcogenide glass from an injection tip of a nozzle and into a cavity of a mold at a flow rate, the nozzle being inserted into the cavity; and
during the depositing, moving at least one of the nozzle and the cavity relative to each other to substantially fill the cavity with the molten chalcogenide glass, and changing the speed of the at least one of the nozzle and the cavity based upon alignment of the injection tip with a cross-sectional radius of the cavity.

2. The method of claim 1, wherein the cavity comprises at least a portion with a relatively smaller cross-sectional radius and a portion with a relatively larger cross-sectional radius, the method further comprising (i) moving the at least one of the nozzle and the cavity at a faster speed when an ejection tip of the nozzle is aligned with the relatively smaller cross-sectional radius of the cavity, and (ii) moving the at least one of the nozzle and the cavity at a slower speed when the ejection tip of the nozzle is aligned with the relatively larger cross-sectional radius of the cavity.

3. The method of claim 2, wherein the faster speed is in a range from about 0.03 m/min to about 0.08 m/min.

4. The method of claim 3, wherein the faster speed is in a range from about 0.04 m/min to about 0.07 m/min.

5. The method of claim 2, wherein the slower speed is in a range from about 0.01 m/min to about 0.03 m/min.

6. The method of claim 5, wherein the slower speed is in a range from about 0.02 m/min to about 0.03 m/min.

7. The method according to claim 1, wherein the depositing comprises depositing the molten chalcogenide glass into a channel of the mold with a smaller radius than a minimum radius of the cavity prior to depositing the molten chalcogenide glass into the cavity.

8. The method of claim 7, wherein the cavity comprises at least a portion with a relatively smaller cross-sectional radius and a portion with a relatively larger cross-sectional radius, the method further comprising (i) moving the at least one of the nozzle and the cavity at a first speed S₁ when an ejection tip of the nozzle is aligned with the channel with the smaller radius than the minimum radius of the cavity, (ii) moving the at least one of the nozzle and the cavity at a second speed S₂ when the ejection tip of the nozzle is aligned with the relatively smaller cross-sectional radius of the cavity, and (iii) moving the at least one of the nozzle and the cavity at a third speed S₃ when the ejection tip of the nozzle is aligned with the relatively larger cross-sectional radius of the cavity, wherein each of the first speed S₁, the second speed S₂, and the third speed S₃ are different from each other.

9. The method of claim 8, wherein the first speed S₁ is greater than the second speed S₂, and the second speed is greater than the third speed S₃.

10. The method of claim 1, further comprising during the depositing, moving the nozzle relative to the cavity.

11. The method of claim 1, further comprising during the depositing, moving the cavity relative to the nozzle.

12. The method of claim 1, wherein a cross-sectional perimeter of the cavity is non-uniform along a length of the cross-section.

13. The method of claim 1, further comprising modifying a speed of the at least one of the nozzle and the cavity during the depositing inversely proportionally to a radius size of a cross-section of the cavity.

14. The method of claim 1, wherein the cavity comprises a plurality of cavities sequentially spaced along a channel of the mold.

15. The method of claim 14, wherein the channel extends substantially linearly.

16. The method of claim 1, wherein the cavity defines a lens shape.

17. The method of claim 1, wherein the molten chalcogenide glass is at a temperature from about 400° C. to about 450° C.

18. The method of claim 1, wherein the flow rate that the molten chalcogenide glass is deposited from the injection tip and into the cavity of the mold is from about 0.01 kg/min to about 0.10 kg/min.

19. The method of claim 18, wherein the flow rate is from about 0.02 kg/min to about 0.09 kg/min.

20. The method of claim 1, wherein the ejection tip remains submerged in the molten chalcogenide glass deposited into the cavity.
